(19) United States
(12) Patent Application Publication
(10) Pub. No.: US 2008/0175219 A1
(43) Pub. Date: Jul. 24, 2008

(54) Method of detecting slot format of physical signaling channel in a wireless communications system and related apparatus

(75) Inventor: Yu-Chih Jen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 12/010,285

(22) Filed: Jan. 23, 2008

Related U.S. Application Data
(60) Provisional application No. 60/886,292, filed on Jan. 23, 2007.

(51) Int. Cl. H04J 3/00

(52) U.S. Cl. 370/345

(57) ABSTRACT

A method for detecting a slot format of a physical signaling channel in a wireless communications system includes using a plurality of pilot bit patterns to distinguish each time slot of each slot format corresponding to the physical signaling channel.

### CROSS REFERENCE TO RELATED APPLICATIONS

This application claims the benefit of U.S. Provisional Application No. 60/886,292, filed on Jan. 23, 2007 and entitled “Method and Apparatus to realize Continuous Packet Connectivity and improve discontinuous transmission and reception”, the contents of which are incorporated herein by reference.

### BACKGROUND OF THE INVENTION

1. Field of the Invention

The present invention relates to a method of detecting slot format of physical signaling channel in a wireless communications system and related apparatus, and more particularly, to a method and related communications apparatus for using pilot bit patterns to distinguish each time slot of each slot format corresponding to the physical signaling channel.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting at the third generation mobile telecommunication technology, the prior art provides High Speed Package Access (HSPA) technology, which includes High Speed Downlink Package Access (HSDPA) and High Speed Uplink Package Access (HSUPA), to increase bandwidth utility rate and package data processing efficiency to improve uplink/downlink transmission rate. For HSDPA and HSUPA, the 3rd Generation Partnership Project (3GPP) provides a Continuous Packet Connectivity (CPC) protocol specification, which includes features that, for user equipments (UEs) in CELL_DCH state, aim to significantly increase the number of packet data users for a cell, reduce the uplink noise rise and improve the achievable download capacity for VoIP.

For an HSDPA UE, physical channels include a high speed physical downlink shared channel (HS-PDSCH), for transferring payload data, and a high speed physical control channel (HS-DPCCH) for uploading an acknowledgement/negative acknowledgement (ACK/NACK) and a channel quality identifier (CQI). As for the media access control (MAC) layer of the HSDPA UE, a MAC-hs entity utilizes a transport channel of High Speed Downlink Shared Channel (HS-DSCH) for receiving data from the physical layer. In addition, a shared control channel for HS-DSCH (HS-SCCH) is used as a physical downlink channel, responsible for transmission of control signals corresponding to HS-DSCH, such as demodulation information.

For an HSUPA UE, physical channels includes two uplink channels: an enhanced dedicated transport channel dedicated physical data channel (E-DPDCH), for transferring payload data, and an E-DCH dedicated physical control channel (E-DPCCH) for transmission of control signals, such as retransmission numbers. Furthermore, a bundle of downlink physical channels are employed in the HSUPA system and used for transmitting control signals associated with grants, ACKs and etc. The downlink physical channels include E-DCH relative grant channel (E-RGCH), E-DCH absolute grant channel (E-AGCH), E-DCH HARQ acknowledgement indicator channel (E-HICH) and fractional dedicated physical channel (F-DPCH). As for the MAC layer of the HSUPA UE, a MAC-e/es entity utilizes a transport channel of enhanced dedicated transport channel (E-DCH) for transmitting MAC packet data to the physical layer with supporting a transmission time interval (TTI) of 10 milliseconds (ms) or 2 ms.

According to the related protocol specifications, in order to reduce the DPCCH overhead or power, the prior art introduces a new DPCCH slot format which is better suited to the case when effectively the only data bits are the TPC (Transmission Power Control) bits. Due to the different DPCCH slot formats, the initiation and termination of CPC operation would be different. However, the bit pattern difference between the pilot bits of the DPCCH slot formats is hard to be distinguished so that the blind slot format detection in non-serving Node Bs in soft handover should be avoided. For a wireless communications system with only hard handover, such as LTE (Long Term Evolution) system, or even forward handover, the pattern difference will be quite useful for slot format detection. However, the prior art does not teach how to implement and how to define the number of pilot bits, and does not specify other related messages and possible applications.

### SUMMARY OF THE INVENTION

According to the present invention, a method for detecting a slot format of a physical signaling channel in a wireless communications system comprises using a plurality of pilot bit patterns to distinguish each time slot of each slot format corresponding to the physical signaling channel.

According to the present invention, a communications device for accurately detecting a slot format of a physical signaling channel in a wireless communications system comprises a control circuit for realizing functions of the communications device, a central processing unit installed in the control circuit for executing a program code to operate the control circuit, and a memory coupled to the central processing unit for storing the program code. The program code comprises using a plurality of pilot bit patterns to distinguish each time slot of each slot format corresponding to the physical signaling channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of the program code shown in FIG. 1.

FIG. 3 is a flowchart diagram of a process according to an embodiment of the present invention.

### DETAILED DESCRIPTION

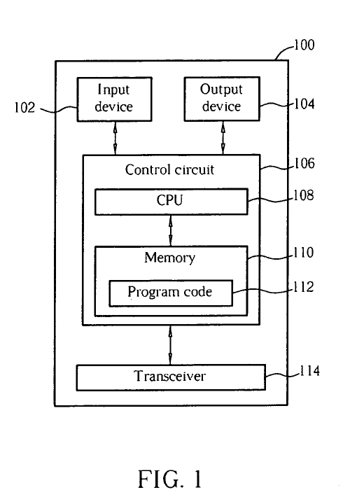

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a High Speed Package Access (HSPA) system of the third generation (3G) mobile communications system, LTE system, or other related communications system, and can be user or network equipment.

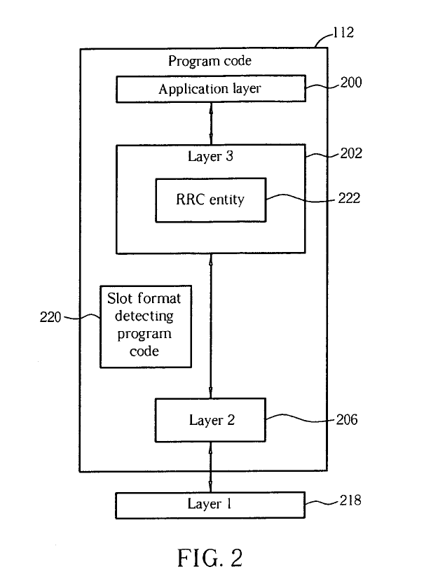

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 includes a radio resource control (RRC) entity 222, which is used for controlling the Layer 1 218 and the Layer 2 206. In addition, when the communications device 100 implements a user equipment, the RRC entity 222 can change an RRC state according to system requirements or radio conditions, to switch between an RRC_IDLE state and an RRC_CONNECTED state. The RRC_CONNECTED state can be CELL_PCH, URA_PCH, CELL_FACH or CELL_DCH state in 3G system.

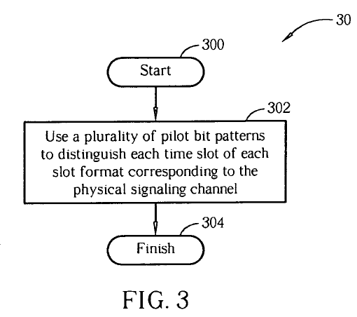

The present invention can perform slot format detection on a physical signaling channel, which includes a physical data channel and a physical control channel, dedicated or shared. In order to reduce overhead and transmission power on the physical signaling channels, the Layer 1 218 can use a new slot format of the dedicated physical signaling channel. In such a situation, the embodiment of the present invention provides a slot format detecting program code 220, for effectively detecting the slot format of the physical signaling channel. Note that, although the slot format detecting program code 220 is implemented in the Layer 2 206 in FIG. 2, it could also be implemented in the Layer 1 218. Whether the slot format detecting program code 220 is implemented in the Layer 2 206 or the Layer 1 218 is not relevant to the present invention. Please refer to FIG. 3, which illustrates a schematic diagram of a process 30. The process 30 is utilized for detecting a slot format of a physical signaling channel in a wireless communications system, and can be compiled into the slot format detecting program code. The process 30 comprises the following steps:
Step 300: Start.
Step 302: Use a plurality of pilot bit patterns to distinguish each time slot of each slot format corresponding to the physical signaling channel.
Step 304: Finish.

According to the process 30, the embodiment of the present invention uses a plurality of pilot bit patterns to distinguish each time slot of each slot format corresponding to the physical signaling channel. In such a situation, the embodiment of the present invention can distinguish or indicate transmitting mode, receiving status, power control information, channel estimation information, coherent detection, transmission loss, control information, or transmission sequence reordering, corresponding to the physical signaling channel, according to the distinguished bit patterns at each time slot of each slot format.

Therefore, via the process 30, for the wireless communications system with only hard handover, such as LTE, or even forward handover, or other handover, the embodiment of the present invention can use pilot bit patterns for slot format detection. Preferably, if there are N time slots per radio frame and M slot formats corresponding to the physical signaling channel, and (N*M)≦2^{p}, then either (p+1) or p bits can be sufficient to construct the pilot bit patterns, where p can be up to the total allowed number of bits of the transmitted message or p plus the number of TPC bits is equal to or smaller than the total allowed number of bits of the transmitted message.

In summary, the embodiment of the present invention uses the pilot bit patterns to distinguish each time slot of each slot format corresponding to the physical signaling channel, so as to improve the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting a slot format of a physical signaling channel in a wireless communications system comprising:
using a plurality of pilot bit patterns to distinguish each time slot of each slot format corresponding to the physical signaling channel.

2. The method of claim 1 further comprising distinguishing or indicating transmitting mode, receiving status, power control information, channel estimation information, coherent detection, transmission loss, control information, or transmission sequence reordering, corresponding to the physical signaling channel, according to the distinguished bit patterns at each time slot of each slot format.

3. The method of claim 1, wherein there are N time slots per radio frame and M slot formats corresponding to the physical signaling channel, and (N*M)≦2^{p}.

4. The method of claim 3, wherein the plurality of pilot bit patterns are represented by (p+1) bits.

5. The method of claim 3, wherein the plurality of pilot bit patterns are represented by p bits.

6. The method of claim 3, wherein p is equal to or smaller than a total allowed number of bits of a transmitted message.

7. The method of claim 3, wherein p plus the number of transmission power control bits is equal to or smaller than a total allowed number of bits of a transmitted message.

8. The method of claim 1, wherein the physical signaling channel comprises a physical data channel and a physical control channel.

9. The method of claim 8, wherein the physical signaling channel is a dedicated channel.

10. The method of claim 8, wherein the physical signaling channel is a shared channel.

11. A communications device for accurately detecting a slot format of a physical signaling channel in a wireless communications system comprising:
a control circuit for realizing functions of the communications device;
a central processing unit installed in the control circuit for executing a program code to operate the control circuit; and
a memory coupled to the central processing unit for storing the program code;
wherein the program code comprises:
using a plurality of pilot bit patterns to distinguish each time slot of each slot format corresponding to the physical signaling channel.

12. The communications device of claim 11, wherein the program code further comprises distinguishing or indicating transmitting mode, receiving status, power control information, channel estimation information, coherent detection, transmission loss, control information, or transmission sequence reordering, corresponding to the physical signaling channel, according to the distinguished bit patterns at each time slot of each slot format.

13. The communications device of claim 11, wherein there are N time slots per radio frame and M slot formats corresponding to the physical signaling channel, and (N*M)≦2^{p}.

14. The communications device of claim 13, wherein the plurality of pilot bit patterns are represented by (p+1) bits.

15. The communications device of claim 13, wherein the plurality of pilot bit patterns are represented by p bits.

16. The communications device of claim 13, wherein p is equal to or smaller than a total allowed number of bits of a transmitted message.

17. The communications device of claim 13, wherein p plus the number of transmission power control bits is equal to or smaller than a total allowed number of bits of a transmitted message.

18. The communications device of claim 11, wherein the physical signaling channel comprises a physical data channel and a physical control channel.

19. The communications device of claim 18, wherein the physical signaling channel is a dedicated channel.

20. The communications device of claim 18, wherein the physical signaling channel is a shared channel.
